(19) United States
(12) Patent Application Publication
(10) Pub. No.: US 2019/0230334 A1
(43) Pub. Date: Jul. 25, 2019

(54) IMAGE PRODUCING APPARATUS AND IMAGE PRODUCING METHOD

(71) Applicant: SONY CORPORATION, Tokyo (JP)

(72) Inventor: Natsuki KANO, KANAGAWA (JP)

(73) Assignee: SONY CORPORATION, Tokyo (JP)

(21) Appl. No.: 16/307,046

(22) PCT Filed: Jun. 1, 2017
(86) PCT No.: PCT/JP2017/020396

§ 371 Date: Dec. 4, 2018

(30) Foreign Application Priority Data
Jun. 15, 2016 (JP) 2016-118578

(51) Int. Cl. H04N 13/128; G06T 5/00; G06T 5/50; H04N 13/25

(52) U.S. Cl. CPC H04N 13/128; G06T 5/009; H04N 2013/0081; H04N 13/25; G06T 5/50

(57) ABSTRACT

The present disclosure relates to an image producing apparatus and an image producing method each of which enables a highly accurate parallax image to be produced. A parallax image producing portion, by using an area in which an exclusion area as at least one area of an overexposure area or an underexposure area within a plurality of exposure pair images photographed at a plurality of exposure values every pair of two points of view, produces a parallax image expressing parallax of the pair of two points of view. The present disclosure, for example, can be applied to an image producing apparatus or the like which produces an HDR omnidirectional image.

### TECHNICAL FIELD

The present disclosure relates to an image producing apparatus and an image producing method, and more particularly to an image producing apparatus and an image producing method each of which enables an accurate parallax image to be produced.

### BACKGROUND ART

In recent years, the research of an image processing technique with multi-view images as an input has been progressed. As far as such an image processing technique, for example, there are a technique with which one sheet of panoramic image is produced by using a photographed image obtained by photographing a wide range while a point of view is moved with a monocular camera, a technique with which three-dimensional information is restored by using a photographed image photographed with a compound eye camera, and the like.

In addition, there is also a technique with which an HDR (High Dynamic Range) image of a predetermined point of view is produced by using a parallax from photographed multi-view images photographed in a plurality of exposure values with one compound eye camera (for example, referred to as PTL 1). Although with the technique described in PTL 1, the photographing is carried out in a plurality of exposure values, the parallax is detected by matching using the multi-view photographed images photographed in the same exposure value.

### CITATION LIST

### Patent Literature

[PTL 1]

JP 2015-207862A

### SUMMARY

### Technical Problem

Therefore, in the case where the exposure value, of the photographed image, which is used in the detection of the parallax is unsuitable, and an overexposure area or an underexposure area is generated in the photographed image, the matching accuracy is deteriorated, and thus it may be impossible to detect the parallax with accuracy.

The present disclosure has been made in the light of such a situation, and enables an accurate parallax image to be produced.

### Solution to Problem

An image producing apparatus of one aspect of the present disclosure is an image producing apparatus provided with a parallax image producing portion for producing a parallax image expressing parallax of a pair of two points of view by using an area obtained by excluding an exclusion area as at least one area of an overexposure area or an underexposure area within a plurality of exposure pair images photographed with a plurality of exposure values every pair of two points of view.

An image producing method of the one aspect of the present disclosure corresponds to the image producing apparatus of the one aspect of the present disclosure.

In the one aspect of the present disclosure, the parallax image expressing the parallax of the pair of two points of view is produced by using an area obtained by excluding the exclusion area as the at least one area of the overexposure area or the underexposure area within the plurality of exposure pair images photographed with the plurality of exposure values every pair of two points of view.

It should be noted that the image producing apparatus of the one aspect of the present disclosure can be realized by causing a computer to execute a program.

In addition, for the purpose of realizing the image producing apparatus of the one aspect of the present disclosure, the program caused to be executed by the computer can be provided by being transmitted through a transmission medium, or by being recorded in a recording medium.

### Advantageous Effect of Invention

According to the one aspect of the present disclosure, the accurate parallax image can be produced.

It should be noted that the effect described here is not necessarily limited, and any of the effects described in the present disclosure may be available.

### BRIEF DESCRIPTION OF DRAWINGS

FIG. 1 is a block diagram depicting an example of a configuration of a first embodiment of an image display system to which the present disclosure is applied.

FIG. 2 is a view depicting a first example of a configuration of a camera module of a photographing apparatus of FIG. 1.

FIG. 3 is a view depicting a second example of a configuration of the camera module of the photographing apparatus of FIG. 1.

FIG. 4 is a block diagram depicting an example of a configuration of an image producing apparatus of FIG. 1.

FIG. 5 is a block diagram depicting an example of a configuration of an image processing portion of FIG. 4.

FIG. 6 is a view depicting an example of an overexposure mask and an underexposure mask.

FIG. 7 is a view depicting an example of an average value Cost (x, y, d).

FIG. 8 is a view explaining an effect in the first embodiment.

FIG. 9 is a view explaining transmission data.

FIG. 10 is a flow chart explaining HDR omnidirectional image production processing of the image producing apparatus of FIG. 1.

FIG. 11 is a flow chart explaining parallax image production processing of FIG. 10.

FIG. 12 is a block diagram depicting an example of a configuration of a display apparatus of FIG. 1.

FIG. 13 is a view depicting a range of pixel values of an HDR omnidirectional image in display points of view.

FIG. 14 is a view depicting a range of pixel values of a display image.

FIG. 15 is a flow chart explaining display processing of the display apparatus of FIG. 12.

FIG. 16 is a block diagram depicting an example of a configuration of an image processing portion in a second embodiment of the image display system to which the present disclosure is applied.

FIG. 17 is a view depicting an example of a mask.

FIG. 18 is a block diagram depicting an example of a configuration of hardware of a computer.

### DESCRIPTION OF EMBODIMENTS

Hereinafter, a description will be given with respect to modes for carrying out the present disclosure (hereinafter referred to as embodiments). It should be noted that the description will be given in accordance with the following order.

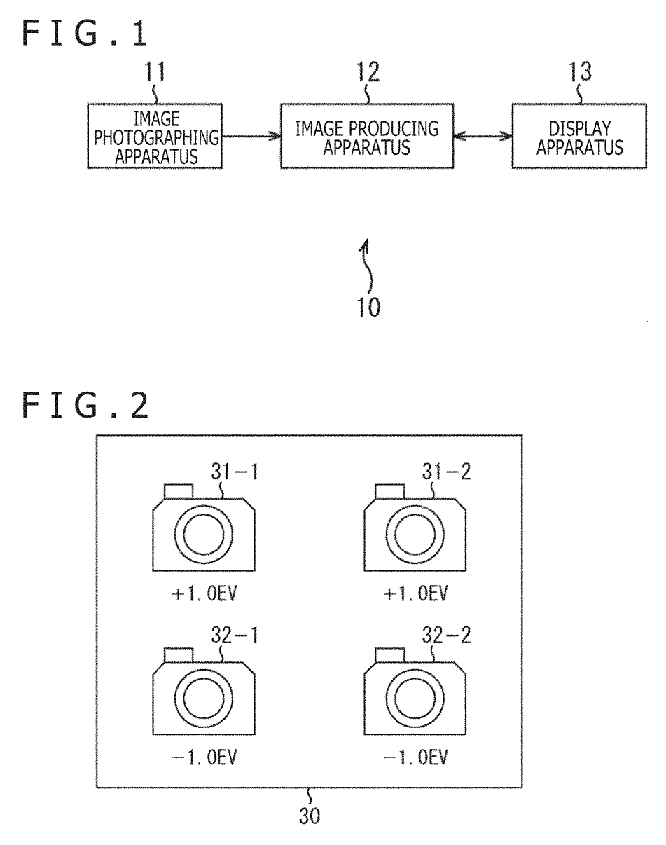

1. First Embodiment: Image Display System (FIG. 1 to FIG. 15)

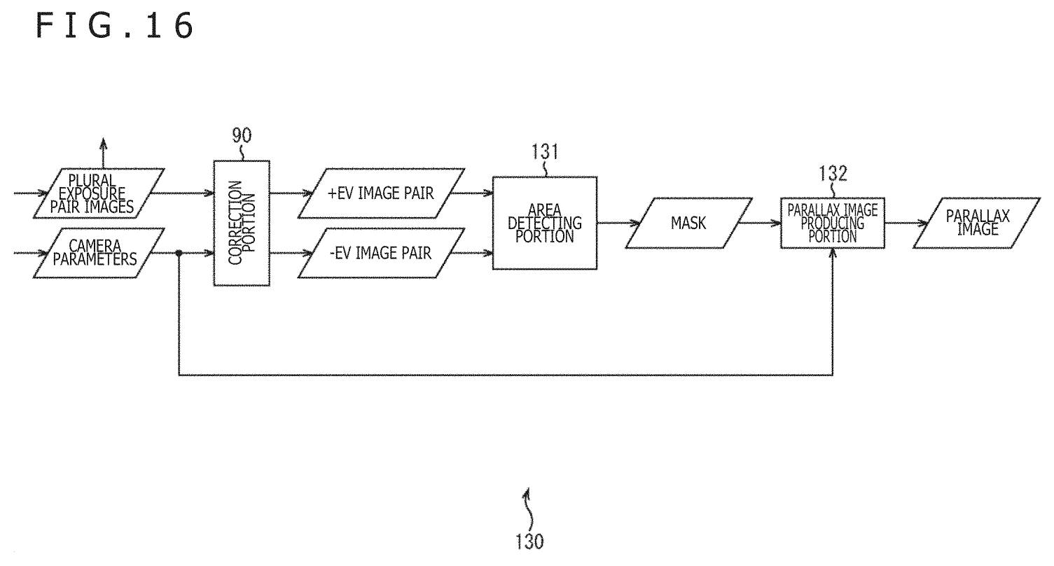

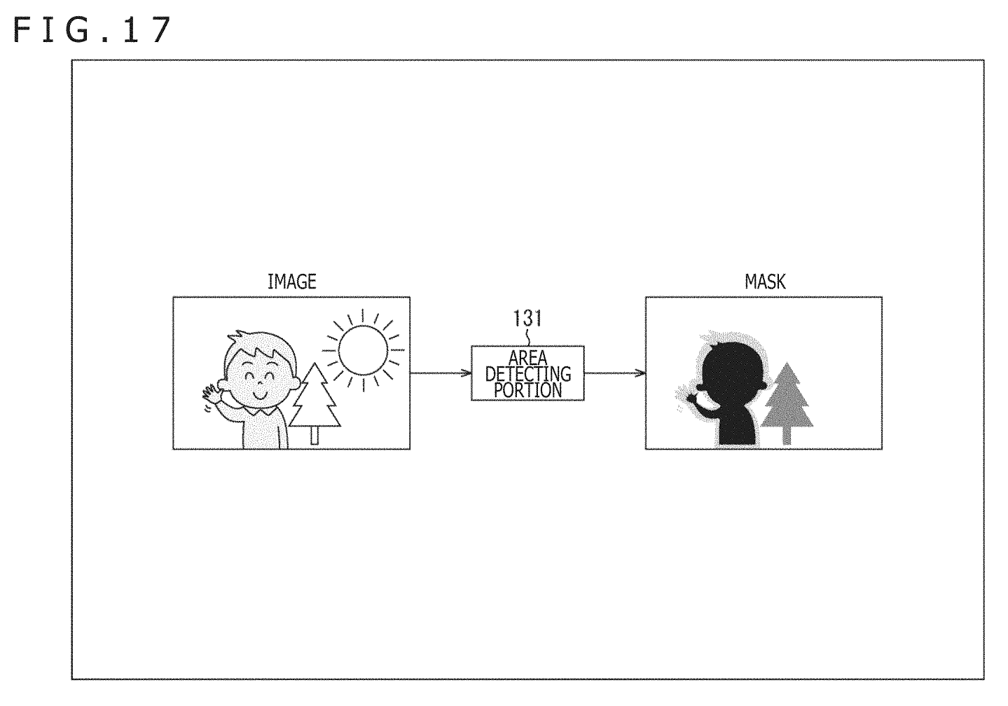

2. Second Embodiment: Image Display System (FIG. 16 and FIG. 17)

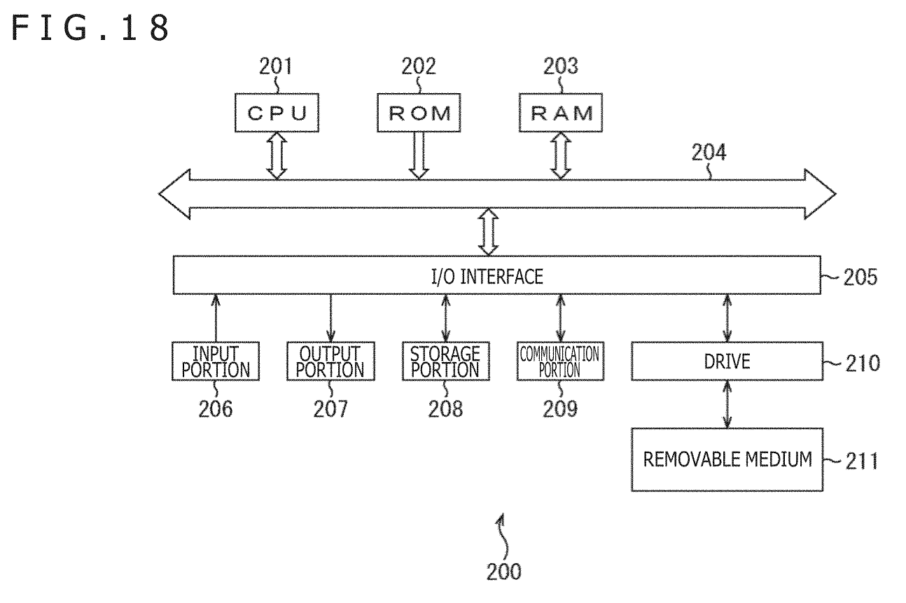

3. Third Embodiment: Computer (FIG. 18)

### First Embodiment

### (Example of Configuration of First Embodiment of Image Display System)

FIG. 1 is a block diagram depicting an example of a configuration of a first embodiment of an image display system to which the present disclosure is applied.

An image display system 10 includes a photographing apparatus 11, an image producing apparatus 12, and a display apparatus 13. The image display system 10 produces and displays a high dynamic range omnidirectional image (hereinafter referred to as an HDR omnidirectional image) by using a plurality of exposure pair images as still images which are photographed with a plurality of exposure values every pair of two points of view.

Specifically, the photographing apparatus 11 of the image display system 10 is configured in such a way that a camera module for photographing a plurality of exposure pair images with each pair of two points of view spreads by 360 degrees in a horizontal direction, and by 180 degrees in a vertical direction. Hereinafter, of a plurality of exposure pair images, the images for which the exposures are identical to each other are referred to as the same exposure pair images, the images for which the points of view are identical to each other are referred to as the same point-of-view images, and in the case where the images of a plurality of exposure pair images do not need to be especially distinguished from one another, these images are simply referred to as the images.

The photographing apparatus 11 carries out calibration for the images of a plurality of exposure pair images of each pair of two points of view photographed with the camera modules. The photographing apparatus 11 supplies data associated with a plurality of exposure pair images of each pair of two points of view, and camera parameters including a position, a posture, a focal length, aberration, and the like of the camera which should photograph the image which are estimated by the calculation for each of the images to the image producing apparatus 12.

The image producing apparatus 12 detects an area in which the matching accuracy of an overexposure area, an underexposure area, or the like of each of the images of a plurality of exposure pair images data associated with which is supplied from the photographing apparatus 11 is deteriorated as an exclusion area which is not used in detection of the parallax. The image producing apparatus 12 produces a parallax image expressing the parallax of a pair of two points of view (depth information expressing a position in a depth direction of a subject) by using the area other than the exclusion area of a plurality of exposure pair images every pair of two points of view. At this time, the image producing apparatus 12, as may be necessary, refers to the camera parallaxes.

The image producing apparatus 12 carries out a three-dimensional re-configuration by using the parallax image of the pair of two points of view, and the same exposure pair images of the optimal exposure value of each of a plurality of pieces of exposure pair images, thereby producing and storing the HDR image of each of the display points of view which spread by 360 degrees in the horizontal direction and by 180 degrees in the vertical direction as the HDR omnidirectional image. The image producing apparatus 12 reads out the data associated with the HDR omnidirectional image of the display point of view based on display point-of-view information, expressing the display point of view of the HDR omnidirectional image as the display target, which is transmitted thereto from the display apparatus 13. The image producing apparatus 12 produces transmission data associated with the HDR omnidirectional image based on the HDR omnidirectional image the data associated with which is read out in such a manner, and transmits the resulting transmission data to the display apparatus 13.

The display apparatus 13 displays thereon the HDR omnidirectional image based on the transmission data transmitted thereto from the image producing apparatus 12. In addition, the display apparatus 13 determines the display point of view of the HDR omnidirectional image as the display target in response to an input or the like from a viewer, and transmits the display point-of-view information to the image producing apparatus 12.

### (First Example of Configuration of Camera Module)

FIG. 2 is a view depicting a first example of a configuration of a camera module of the photographing apparatus 11 of FIG. 1.

In the example of FIG. 2, the exposure values (EV) of a plurality of exposure pair images are +1.0 and −1.0. Therefore, a camera module 30 of the photographing apparatus 11 of FIG. 2 includes a camera 31-1 and a camera 31-2 which photograph pair images of two points of view arranged side by side in a horizontal direction with the exposure value of +1.0, and a camera 32-1 and a camera 32-2 which photograph pair images of two points of view arranged side by side in the horizontal direction with the exposure value of −1.0. In addition, in the example of FIG. 2, the camera 31-1 and the camera 32-2, and the camera 31-2 and the camera 31-2 are respectively disposed so as to be arranged side by side in a vertical direction.

That is, the camera module 30 includes the camera 31-1, the camera 31-2, the camera 32-1, and the camera 32-2 (photographing apparatus) which are provided every point of view and every exposure value, and are arranged in 2 (horizontal direction)×2 (vertical direction). It should be noted that in the case where hereinafter, the camera 31-1, the camera 31-2, the camera 32-1, and the camera 32-2 do not need to be especially distinguished from one another, those will be collectively referred to as the cameras 31 (32).

As described above, since in the camera module 30 of FIG. 2, the camera 31 (32) is provided every point of view, and every exposure value, a plurality of exposure pair images can be entirely, simultaneously photographed. Therefore, the camera module 30 is suitable for the case as well where not only a still image, but also a time-lapse image or a moving image which is obtained by carrying out continuous shooting at a given interval are photographed as a plurality of exposure pair images.

It should be noted that although since in the example of FIG. 2, the number of kinds of exposure values of a plurality of exposure pair images is two, the number of cameras 31 (32) configuring the camera module 30 is four, the number of cameras (32) differs depending on the number of kinds of exposure values. For example, in the case where the number of kinds of exposure values of a plurality of exposure pair images is five: +2.0, −1.0, 0.0, +1.0, and +2.0, the number of cameras 31 (32) is ten. As the number of kinds of exposure values of a plurality of exposure pair images is larger, a dynamic range of the HDR omnidirectional image can be enhanced.

In addition, the paired cameras 31 (32) of two points of view do not need to be necessarily arranged in parallel to each other. However, in the case where the paired cameras 31 (32) of two points of view are arranged in parallel to each other, areas which overlap each other in the images of two points of view become wider. As will be described later, since the parallax is detected by the block matching using a plurality of exposure pair images of two points of view, in the case where the paired cameras 31 (32) of two points of view are arranged in parallel to each other, the area in which the parallax can be accurately detected becomes wider.

### (Second Example of Configuration of Camera Module)

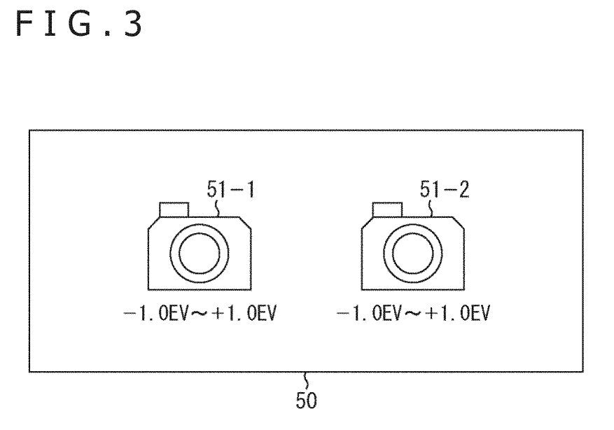

FIG. 3 is a view depicting a second example of a configuration of the camera module of the photographing apparatus 11 of FIG. 1.

Although in the example of FIG. 3, similarly to the case of FIG. 2, the exposure values of a plurality of exposure pair images are +1.0 and −1.0, the camera module 50 of the photographing apparatus 11 of FIG. 3 is provided only two cameras: a camera 51-1; and a camera 51-2 which are arranged side by side in the horizontal direction. That is, the camera module 50 includes the camera 51-1 and the camera 51-2 (photographing apparatus) which are provided every point of view and are arranged in 2 (horizontal direction)×1 (vertical direction). It should be noted that in the case where hereinafter, the camera 51-1 and the camera 51-2 do not need to be especially distinguished from each other, they are collectively referred to as the cameras 51.

In the camera module 50 of FIG. 30, the cameras 51 carry out the photographing in which the exposure value is changed in order between +1.0 and −1.0 (carry out AE (Automatic Exposure) bracket shooting), resulting in that a plurality of exposure pair images in which the exposure values are +1.0 and −1.0 are photographed, and the pieces of photographing time of the plurality of exposure pair images are set as the same time. That is, of a plurality of exposure pair images, the photographing time of the same exposure pair images in which the exposure value is +1.0, and the photographing time of the same exposure pair images in which the exposure value is −1.0 are actually continuously different pieces of time, but are set so as the same time.

Since it may be impossible for the camera module 50 to simultaneously photograph a plurality of exposure pair images, the camera module 50 is suitable for the case where a still image or a time-lapse image is photographed as a plurality of exposure pair images.

It should be noted that since in the camera module 50 of FIG. 30, the camera 51 is provided every point of view, the number of cameras 51 configuring the camera module 50 is not changed depending on the kinds of exposure values of a plurality of exposure pair images. For example, even in the case where the number of kinds of exposure values of a plurality of exposure pair images is five: +2.0, −1.0, 0.0, +1.0, and +2.0, the number of cameras 51 is two. In addition, similarly to the case of FIG. 2, the paired cameras 51 of two points of view do not need to be necessarily arranged in parallel to each other.

### (Example of Configuration of Image Producing Apparatus)

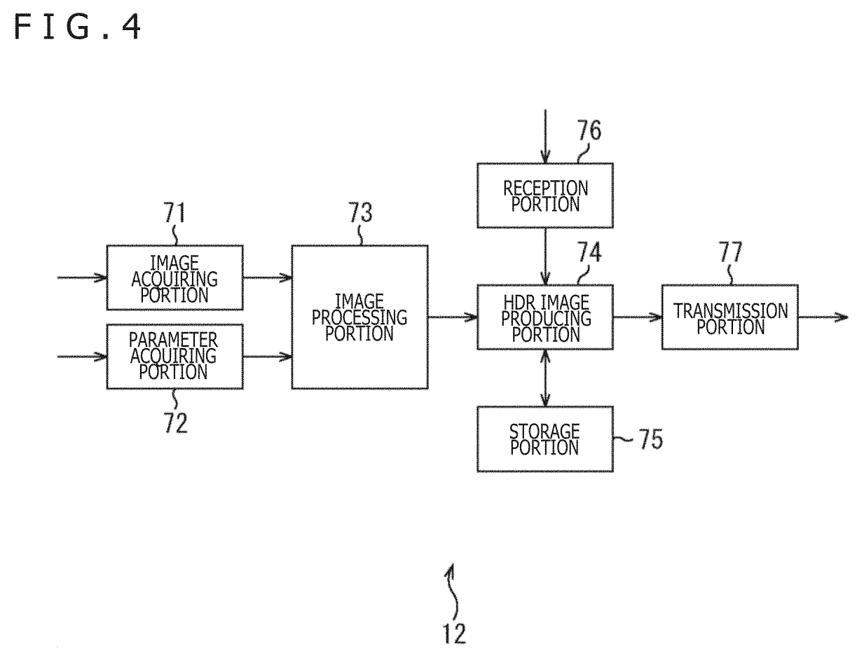

FIG. 4 is a block diagram depicting an example of a configuration of the image producing apparatus 12 of FIG. 1.

The image producing apparatus 12 of FIG. 4 includes an image acquiring portion 71, a parameter acquiring portion 72, an image processing portion 73, an HDR image producing portion 74, a storage portion 75, a reception portion 76, and a transmission portion 77.

The image acquiring portion 71 of the image producing apparatus 12 acquires a plurality of exposure pair images, of each two points of view, data associated with which is supplied thereto from the photographing apparatus 11, and supplies data associated with the plurality of exposure pair images to the image processing portion 73. The parameter acquiring portion 72 acquires the camera parameters of the images supplied thereto from the photographing apparatus 11, and supplies the camera parameters of the images to the image processing portion 73.

The image processing portion 73 corrects the image of a plurality of exposure pair images the data associated with which is supplied thereto from the image acquiring portion 71 based on the aberration of the camera parameters, of each of the images, which are supplied thereto from the parameter acquiring portion 72. The image processing portion 73 detects the overexposure area and the underexposure area of each of the images after the correction as the exclusion areas. The image processing portion 73 produces the parallax image of the paired two points of view every paired two points of view by using the position, the posture, and the focal length of the camera of the camera parameters, and the area other than the exclusion area of a plurality of exposure pair images after the correction. The image processing portion 73 supplies the parallax image of each paired two points of view, and a plurality of exposure pair images to the HDR image producing portion 74.

The HDR image producing portion 74 carries out the three-dimensional re-configuration by using the parallax image of each pair of two points of view, and the same exposure pair images of the optimal exposure value of each plurality of exposure pair images the pieces of data associated with which are supplied from the image processing portion 73, thereby producing the HDR omnidirectional image of each of the display points of view. The HDR image producing portion 74 supplies the data associated with the HDR omnidirectional image of each of the display points of view to the storage portion 75 and causes the storage portion 75 to store therein the data associated with the HDR omnidirectional image of each of the display points of view.

In addition, the HDR image producing portion 74 reads out the data associated with the HDR omnidirectional image of the display point of view indicated by display point-of-view information supplied thereto from the reception portion 76 from the storage portion 75, and supplies the data associated with the HDR omnidirectional image of the display point of view thus read out to the transmission portion 77.

The storage portion 75 stores therein the data associated with the HDR omnidirectional image of the display points of view supplied thereto from the HDR image producing portion 74. The reception portion 76 receives the display point-of-view information transmitted thereto from the display apparatus 13 of FIG. 1, and supplies the display point-of-view information to the HDR image producing portion 74.

The transmission portion 77 transforms the number of bits of the data, associated with the HDR omnidirectional image, which is supplied thereto from the HDR image producing portion 74 into the number of bits for the transmission, and produces the transmission data containing therein the data associated with the HDR omnidirectional image of the number of bits for the transmission, and the restored data. The restored data is metadata which is used when the data associated with the HDR omnidirectional image of the number of bits for the transmission is returned back to the data associated with the HDR omnidirectional image of the number of bits before the transformation. The HDR image producing portion 74 transmits the transmission data to the display apparatus 13 of FIG. 1.

### (Example of Configuration of Image Processing Portion)

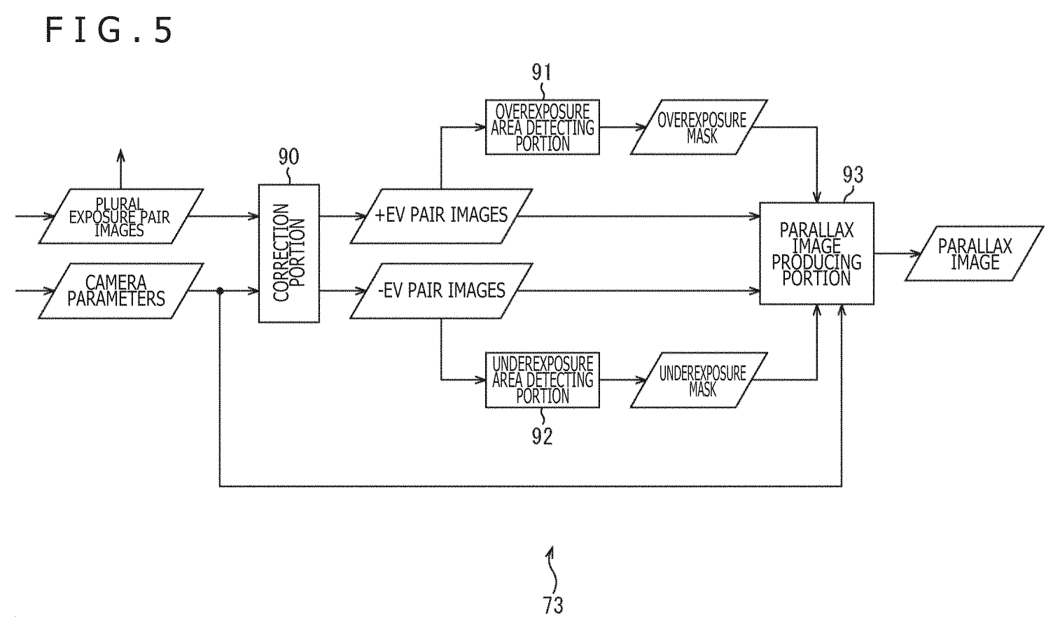

FIG. 5 is a block diagram depicting an example of a configuration of the image processing portion 73 of FIG. 4.

The image processing portion 73 of FIG. 5 includes a correction portion 90, an overexposure area detecting portion 91, an underexposure area detecting portion 92, and a parallax image producing portion 93.

The data associated with a plurality of exposure pair images of each two points of view which is inputted from the image acquiring portion 71 of FIG. 4 is inputted to the correction portion 90, and is outputted to the HDR image producing portion 74 of FIG. 4. In addition, the camera parameters, of each of the images, which are inputted from the parameter acquiring portion 72 are supplied to each of the correction portion 90 and the parallax image producing portion 93.

The correction portion 90 corrects the image based on the aberration of the camera parameters of each of the images of a plurality of exposure pair images. The correction portion 90 supplies the data associated with the same exposure pair images, for each of which the exposure value is equal to or larger than 0, of a plurality of exposure pair images after the correction as the data associated with the +EV pair images to each of the overexposure area detecting portion 91 and the parallax image producing portion 93. In addition, the correction portion 90 supplies the data associated with the same exposure pair images, for each of which the exposure value is negative, of a plurality of exposure pair images after the correction as the data associated with the −EV pair images to each of the overexposure area detecting portion 91 and the parallax image producing portion 93.

The overexposure area detecting portion 91 detects an overexposure area of each of the images of the +EV pair images the data associated with which is supplied thereto from the correction portion 90. Specifically, the overexposure area detecting portion 91 partitions each of the images into blocks each having a predetermined size, and produces a histogram of the pixel values of the blocks. Then, the overexposure area detecting portion 91 detects the block in which there are many pixel values each larger than a threshold value for overexposure area decision as the overexposure area based on the histogram of the blocks. The overexposure area detecting portion 91 produces an overexposure mask for masking the overexposure area every image, and data associated with the resulting overexposure mask to the parallax image producing portion 93.

The underexposure area detecting portion 92 detects an underexposure area of each of the images of the −EV pair images the data associated with which is supplied thereto from the correction portion 90. Specifically, the underexposure area detecting portion 92 partitions each of the images into blocks each having a predetermined size, and produces a histogram of the pixel values of the blocks. Then, the underexposure area detecting portion 92 detects the block in which there are many pixel values each smaller than a threshold value for underexposure area decision as the underexposure area based on the histogram of the blocks. The underexposure area detecting portion 92 produces an underexposure mask for masking the underexposure area every image, and data associated with the resulting underexposure mask to the parallax image producing portion 93.

The parallax image producing portion 93 makes the overexposure area of each of the images an exclusion area by using the overexposure mask of the image for each of the images of the +EV pair images the data associated with which is supplied thereto from the correction portion 90. In addition, the parallax image producing portion 93 makes the underexposure area of each of the images an exclusion area by using the underexposure mask of the image for each of the images of the −EV pair images the data associated with which is supplied thereto from the correction portion 90.

The parallax image producing portion 93 detects the parallax of a pair of two points of view by using a plurality of exposure pair images in each of which the overexposure area or the underexposure area is made the exclusion area, for example, in accordance with a Plane Sweep method, thereby producing the parallax image.

Specifically, the parallax image producing portion 93 projection-transforms the same exposure pair images in which the overexposure area or the underexposure area is made the exclusion area with respect to a center reference point of view into the positions d in the depth direction corresponding to the parallax becoming candidates within a predetermined image, and produces an image of the reference point of view in the case where a subject is present in each of the positions d.

Then, the parallax image producing portion 93 carries out the block matching between the images of the reference points of view every position d so as to follow following Expression (1), thereby calculating matching costs of the blocks. It should be noted that the range of the parallaxes becoming the candidates is determined based on the position, the posture, and the focal length of the camera of the camera parameters. In addition, the block includes one or more pixels.

[Math. 1]

Sub_Cost(x,y,d)=|I₀(x,y,d)−I₁(x,y,d)| (1)

It should be noted that Sub_Cost(x, y, d) is the matching cost of the block in the position (x, y) within the image of the reference point of view in the case where the subject is present in the position d. I₀(x, y, d) is (pixel values of) the block in the position (x, y) within the image of the reference point of view in the case where the subject is present in the position d, corresponding to one of a pair of two points of view. In addition, I₁(x, y, d) is (pixel values of) the block in the position (x, y) within the image of the reference point of view in the case where the subject is present in the position d, corresponding to the other of a pair of two points of view.

According to Expression (1), the matching cost Sub_Cost(x, y, d) is an absolute error between the block I₀(x, y, d) and the block I₁(x, y, d). It should be noted that the matching cost Sub_Cost(x, y, d) is not calculated in the case where the exclusion area is included in one of the block I₀(x, y, d) and the block I₁(x, y, d). In addition, the matching cost Sub_Cost(x, y, d) may be a square error or the like between the block I₀ (x, y, d) and the block I₁(x, y, d).

The parallax image producing portion 93 averages the matching costs Sub_Cost(x, y, d) of all the exposure values calculated every pair of two points of view so as to follow following Expression (2).

$$\begin{matrix}[ Math . 2 ] & \\ Cost ( x , y , d ) = \frac{1}{N} {\sum }_{n = 0}^{N} Sub\_Cost ( x , y , d ) & ( 2 )\end{matrix}$$

Cost(x, y, d) is an average value of the matching costs Sub_Cost(x, y, d), and N is the number of calculated matching costs Sub_Cost(x, y, d).

The parallax image producing portion 93 detects the position d in the case where the average value Cost(x, y, d) is smallest as the parallax every block, and produces the parallax image of the reference point of view. The parallax image producing portion 93 supplies the data associated with the parallax image of the reference point of view of each pair of two points of view to the HDR image producing portion 74 of FIG. 4.

### (Example of Overexposure Mask and Underexposure Mask)

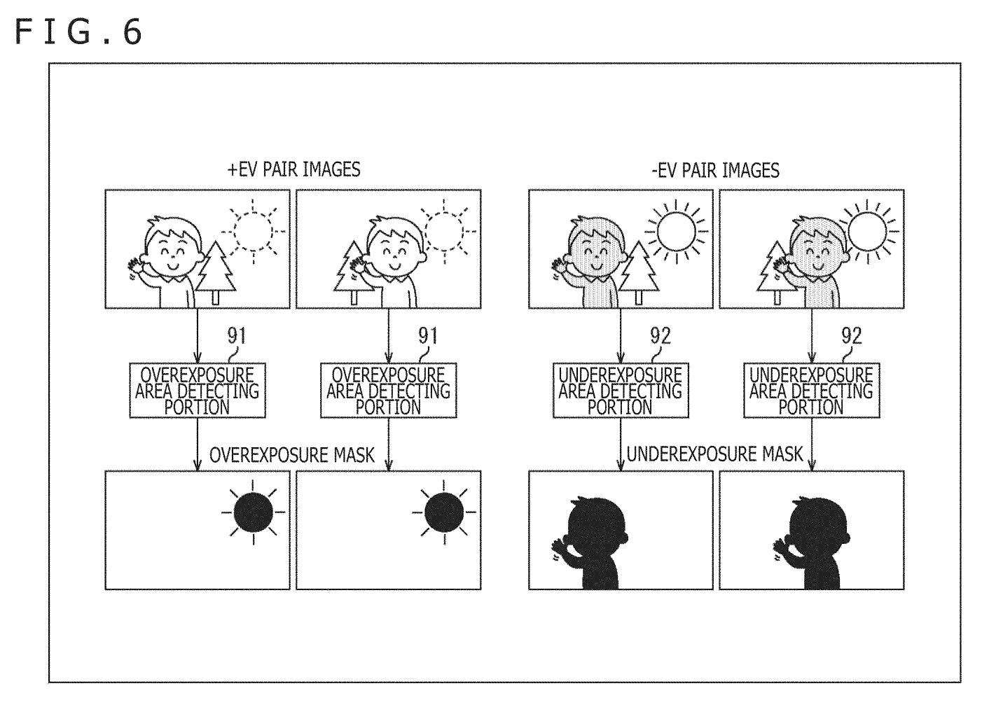

FIG. 6 is a view depicting an example of the overexposure mask and the underexposure mask.

In the example of FIG. 6, the subjects are a person, a tree, and the sun, and the person is present in the front of the sun. Then, when +EV pair images are photographed at the exposure value suitable for the person, the sun undergoes the overexposure, and when −EV pair images are photographed at the exposure value suitable for the sun, the person undergoes the underexposure.

In this case, the overexposure area detecting portion 91 detects an area of the sun within the +EV pair images as the overexposure area. Therefore, the overexposure area detecting portion 91 produces a binary overexposure mask in which the area of the sun within each of the images of the +EV pair images is made the exclusion area (a black area in the figure), and an area other than the area of the sun is made a valid area (a white area in the figure).

In addition, the underexposure area detecting portion 92 detects an area of the person within the −EV pair images as the underexposure area. Therefore, the underexposure area detecting portion 92 produces a binary underexposure mask in which the area of the person within each of the images of the −EV pair images is made the exclusion area (a black area in the figure), and an area other than the area of the person is made a valid area (a white area in the figure).

### (Example of Average Value Cost(x, y, d))

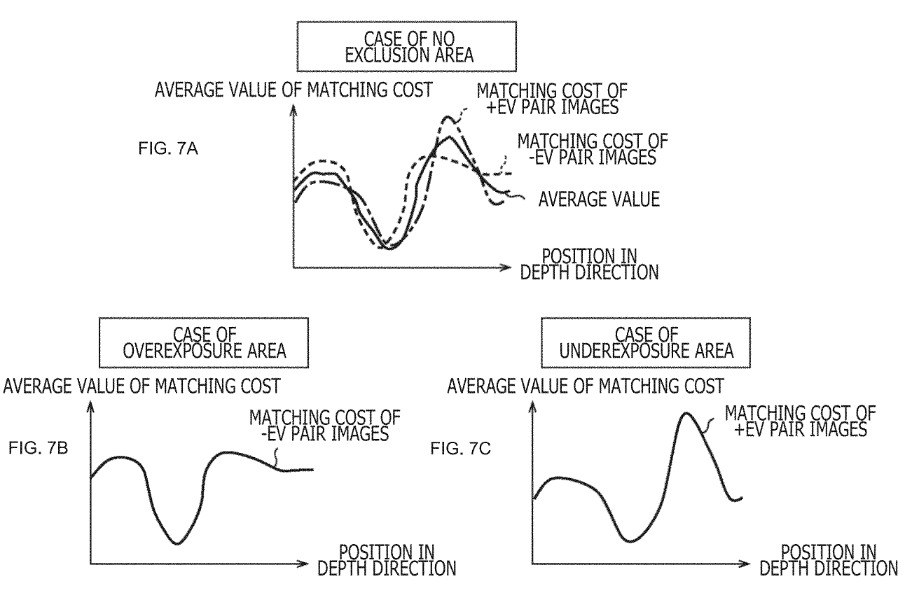

FIG. 7 is a view depicting an example of the average value Cost (x, y, d).

In a graph of FIG. 7, an axis of abscissa represents the position d in a depth direction and an axis of ordinate represents the average value Cost(x, y, d) of the matching costs. In addition, in the example of FIG. 7, a plurality of exposure pair images includes one +EV pair images and one −EV pair images.

In this case, in the case where as depicted in A of FIG. 7, all the blocks of the positions (x, y) of the images of the two reference points of view produced from the +EV pair images, and the blocks of the positions (x, y) of the images of the two reference points of view produced from the −EV pair images are not the exclusion areas, the average value Cost(x, y, d) becomes as indicated by a solid line in A of FIG. 7. That is, the average value Cost(x, y, d) is an average value of the matching costs Sub_Cost(x, y, d) which are respectively produced from the +EV pair images and the −EV pair images.

On the other hand, in the case as depicted in B of FIG. 7, at least one of the blocks of the positions (x, y) of the images of the two reference points of view produced from the +EV pair images is the overexposure area, the matching cost Sub_Cost(x, y, d) is not produced from the +EV pair images. Therefore, the average value Cost(x, y, d) becomes the matching cost Sub_Cost(x, y, d) produced from the +EV pair images and indicated by a solid line in B of FIG. 7.

In addition, in the case as depicted in C of FIG. 7, at least one of the blocks of the positions (x, y) of the images of the two reference points of view produced from the −EV pair images is the underexposure area, the matching cost Sub_Cost(x, y, d) is not produced from the −EV pair images. Therefore, the average value Cost(x, y, d) becomes the matching cost Sub_Cost(x, y, d) produced from the +EV pair images and indicated by a solid line in C of FIG. 7.

As described above, the average value Cost(x, y, d) is produced by using the matching cost Sub_Cost(x, y, d) of the area other than either the overexposure area or the underexposure area.

Therefore, the parallax image producing portion 93 can accurately detect the parallax between the blocks as the areas other than the exclusion areas of both the +EV pair images and the −EV pair images by using both the +EV pair images and the −EV pair images. In addition, the parallax image producing portion 93 can accurately detect the parallax of the block as the overexposure area of at least one of the +EV pair images by using only the −EV pair images. Moreover, the parallax image producing portion 93 can accurately detect the parallax of the block as the underexposure area of at least one of the −EV pair images by using only the +EV pair images.

### Description of Effects

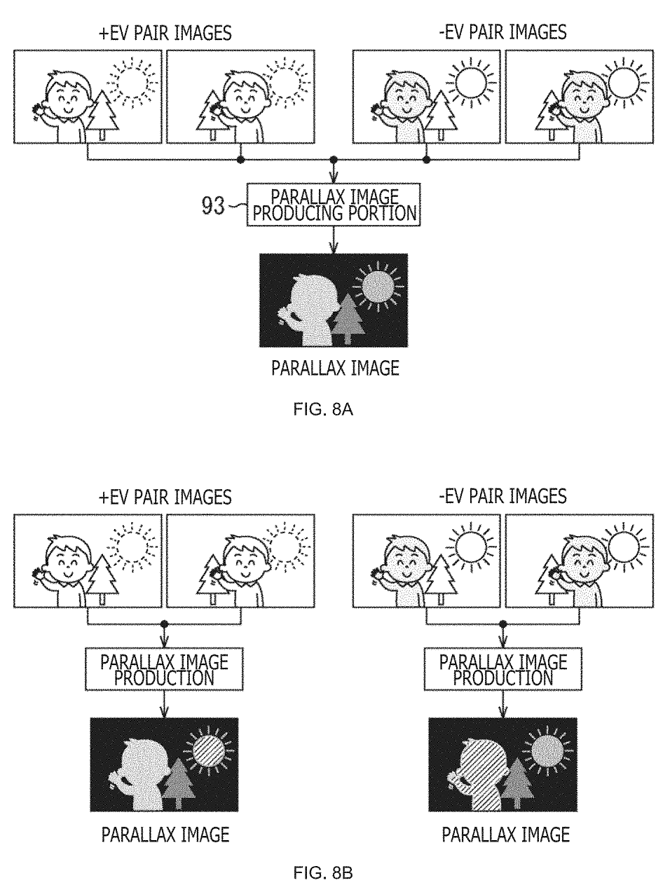

FIG. 8 is a view explaining the effects in the first embodiment.

The +EV pair images and the −EV pair images of FIG. 8 are the same as those of FIG. 6. In addition, in an example of FIG. 8, a plurality of exposure pair images includes one +EV pair images and one −EV pair images.

As depicted in A of FIG. 8, the parallax image producing portion 93 produces the parallax image by using the areas other than the exclusion areas of the +EV pair images and the −EV pair images. Therefore, the parallax image producing portion 93 can accurately detect the parallax between the blocks as the areas other than the exclusion areas of the +EV pair images and the −EV pair images by using the +EV pair images and the −EV pair images.

In addition, the parallax image producing portion 93 can accurately detect the parallax of the block as at least one of the overexposure area of the +EV pair images by using only the −EV pair images. Moreover, the parallax image producing portion 93 can accurately detect the parallax of the block as at least one of the underexposure areas of the −EV pair by using only the +EV pair images. As a result, as depicted in A of FIG. 8, the parallax image for which the accuracy is not deteriorated even in the overexposure area or the underexposure area can be produced.

On the other hand, as depicted on the left-hand side of B of FIG. 8, in the case where the parallax image is produced from only the +EV pair images, since the accuracy of the matching of the area of the sun as the overexposure area within the image of the reference point of view is deteriorated, the accuracy of the parallax mage of the area of the sun is deteriorated. In addition, as depicted on the right-hand side of B of FIG. 8, in the case where the parallax image is produced from only the −EV pair images, since the accuracy of the matching of the area of the person as the underexposure area within the image of the reference point of view is deteriorated, the accuracy of the parallax mage of the area of the person is deteriorated.

### (Description of Transmission Data)

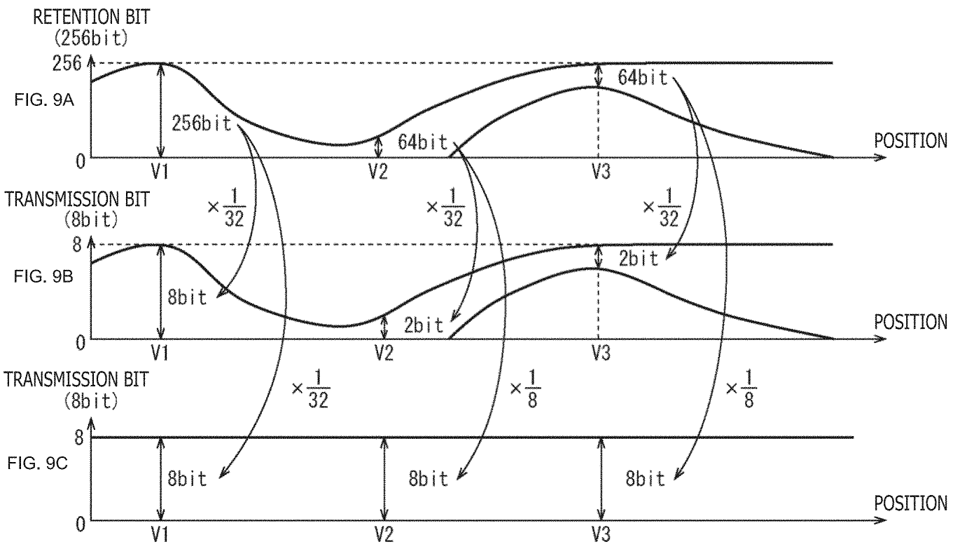

FIG. 9 is a view explaining the transmission data.

In a graph of FIG. 9, an axis of abscissa represents the position of the display point of view, and an axis of ordinate represents the transmission bits as the retention bits as the use bits of the HDR omnidirectional images of the display points of view which are retained in the storage portion 75, or the use bits of the HDR omnidirectional images of the display points of view which are contained in the transmission data.

In addition, in the example of FIG. 9, the number of bits for the retention of the HDR omnidirectional images of the display points of view which are retained in the storage portion 75 is 256 bits and the number of bits for the transmission of the HDR omnidirectional images of the display points of view which are contained in the transmission data is 8 bits.

In the case where the number of bits for the retention of the HDR omnidirectional images of the display points of view is transformed into the number of bits for the transmission, in general, the number of bits for the retention of the HDR omnidirectional images of the display points of view is multiplied by the number of bits as large as times the number of bits for the transmission/the number of bits for the retention (in the example of FIG. 9, 8/256 (=1/32) times).

As a result, for example, as depicted in A of FIG. 9, the transmission bits of the HDR omnidirectional image of a display point V1 of view falling within the range in which the number of retention bits is 0 bit to 256 bits, as depicted in B of FIG. 9, fall within the range of 0 bit to 8 bits. In addition, as depicted in A of FIG. 9, the transmission bits of the HDR omnidirectional image of a display point V2 of view falling within the range in which the number of retention bits is 0 bit to 64 bits, as depicted in B of FIG. 9, fall within the range of 0 bit to 2 bits.

Moreover, as depicted in A of FIG. 9, the transmission bits of the HDR omnidirectional image of a display point V3 of view falling within the range in which the number of retention bits is 192 bits to 256 bits, as depicted in B of FIG. 9, fall within the range of 6 bits to 8 bits.

On the other hand, the transmission portion 77 subtracts a minimum value of the pixel values from the pixel values of the HDR omnidirectional image of the display point of view of the number of bits for the retention. The transmission portion 77 transforms the number of bits of the resulting difference into the number of bits for the transmission, thereby transferring the number of bits for the retention of the HDR omnidirectional image of the display point of view into the number of bits for the transmission.

For example, as depicted in A of FIG. 9, the transmission portion 77 subtracts 0 as the minimum value of the pixel values from the pixel values of the HDR omnidirectional image of the display point V1 of view falling within the range in which the number of the retention bits is 0 bit to 256 bits. Then, as depicted in C of FIG. 9, the transmission portion 77 multiplies the number of bits of the difference as the resulting 256 bits by 8/256 (=1/32) times to obtain 8 bits and sets the resulting value of 8 bits as the pixel value of the HDR omnidirectional image of the display point V1 of view of the number of bits for the transmission.

In addition, as depicted in A of FIG. 9, the transmission portion 77 subtracts 0 as the minimum value of the pixel values from the pixel value of the HDR omnidirectional image of the display point V2 of view falling within the range in which the number of retention bits is 0 bit to 64 bits. Then, as depicted in C of FIG. 9, the transmission portion 77 multiples the number of bits as the resulting difference of 64 bits by 64/256 (=1/8) times to obtain 8 bits. Then, the transmission portion 77 sets the resulting value of 8 bits as the pixel value of the HDR omnidirectional image of the display point V2 of view of the number of bits for the transmission.

Moreover, as depicted in A of FIG. 9, the transmission portion 77 subtracts 2¹⁹²−1 as the minimum value of the pixel values from the pixel values of the HDR omnidirectional image of the display point V3 of view falling within the range in which the number of retention bits is 192 bits to 256 bits. Then, as depicted in C of FIG. 9, the transmission portion 77 multiples the number of bits as the resulting difference of 64 bits by 64/256 (=1/8) times to obtain 8 bits. Then, the transmission portion 77 sets the resulting value of 8 bits as the pixel value of the HDR omnidirectional image of the display point V3 of view of the number of bits for the transmission.

As described above, the transmission portion 77 does not transform the pixel value itself of the HDR omnidirectional image, but transforms the number of bits of the difference with the minimum value of the pixel values into the number of bits for the transmission. Therefore, in the case where the number of retention bits of the HDR omnidirectional image is smaller than the number of bits for the retention, the retention of the gradation due to the transmission can be suppressed as compared with the case where the number of bits of the pixel value itself of the HDR omnidirectional image is transformed. That is, in the display point V2 of view or in the display point V3 of view, in the case where the number of bits of the pixel value itself of the HDR omnidirectional image is transformed, the gradation becomes 1/32 times. However, in the case where the number of bits of the difference with the minimum value of the pixel values is transformed into the number of bits for the transmission, the gradation becomes 1/8 times.

In addition, for returning the number of bits of the HDR omnidirectional image of 8 bits produced in the manner as described above back to the original 256 bits, there is required the range of the pixel value of the HDR omnidirectional image before the transformation of the number of bits. Therefore, the transmission portion 77 produces the transmission data with the range of the pixel values of the HDR omnidirectional image before the transformation of the number of bits being included together with the HDR omnidirectional image of 8 bits as the restored data in the transmission data, and transmits the resulting transmission data to the display apparatus 13.

It should be noted that the restored data may not be the range itself as long as the restored data is information indicating the range of the pixel values of the HDR omnidirectional image before the transformation of the number of bits. For example, information indicating what number of the portion from the bottom when how many parts into which the number of bits for the retention is partitioned (for example, the first partition number from the bottom when four partitions are carried out in case of the display point V2 of view) may be available. In addition, the minimum value of the pixel values each of which is subtracted from the pixel values of the HDR omnidirectional image may also be the minimum value of the pixel value of the HDR omnidirectional image at the display point of view in the predetermined range including that HDR omnidirectional image. In this case, the restored data may be transmitted every transmission of the HDR omnidirectional image at the display point of view in the predetermined range.

### (Description of Processing of Image Producing Apparatus)

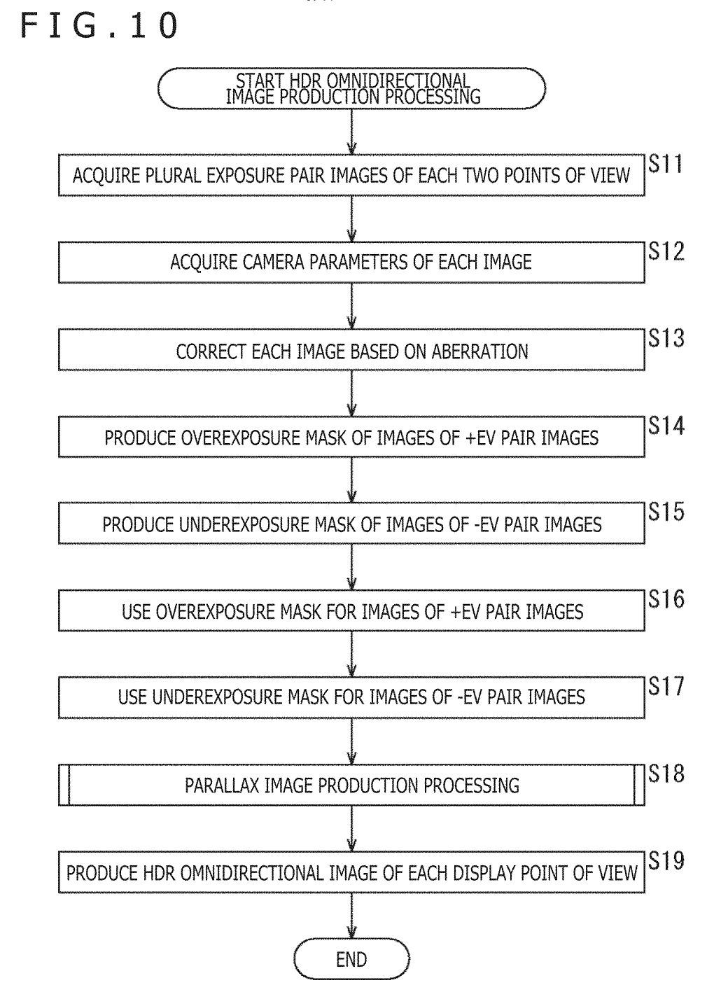

FIG. 10 is a flow chart explaining the HDR omnidirectional image production processing of the image producing apparatus 12 of FIG. 1. The HDR omnidirectional image production processing, for example, is started when a plurality of exposure pair images of each two points of view, and the camera parameters of each image are supplied from the photographing apparatus 11 of FIG. 1.

In Step S11 of FIG. 10, the image acquiring portion 71 of the image producing apparatus 12 acquires a plurality of exposure pair images, of each two points of view, the data associated with which is supplied from the photographing apparatus 11. The image acquiring portion 71 supplies the data associated with a plurality of exposure pair images thus acquired to the image processing portion 73, and supplies the same to the HDR image producing portion 74 through the image processing portion 73. In Step S12, the parameter acquiring portion 72 acquires the camera parameters of each image, which are supplied from the photographing apparatus 11, and supplies the camera parameters thus acquired to the image processing portion 73.

In Step S13, the correction portion 90 of the image processing portion 73 corrects each image of a plurality of exposure pair images the data associated with which is supplied from the image acquiring portion 71 based on the aberration of the camera parameters of each image, which are supplied from the parameter acquiring portion 72. The correction portion 90 supplies the data associated with the +EV pair images of a plurality of exposure pair images after the correction to each of the overexposure area detecting portion 91 and the parallax image producing portion 93, and supplies the data associated with the −EV pair images to each of the overexposure area detecting portion 91 and the parallax image producing portion 93.

In Step S14, the overexposure area detecting portion 91 detects the overexposure area of each image of the +EV pair images the data associated with which is supplied from the correction portion 90 to produce the overexposure mask, and supplies the overexposure mask to the parallax image producing portion 93. In Step S15, the underexposure area detecting portion 92 detects the underexposure area of each image of the −EV pair images the data associated with which is supplied from the correction portion 90 to produce the underexposure mask, and supplies the underexposure mask to the parallax image producing portion 93.

In Step S16, the parallax image producing portion 93 uses the overexposure mask of the image for each image of the +EV pair images the data associated with which is supplied from the correction portion 90, thereby making the overexposure mask of the image for each image the exclusion area. In Step S17, the parallax image producing portion 93 uses the underexposure mask of the image for each image of the −EV pair images the data associated with which is supplied from the correction portion 90, thereby making the underexposure area of the image for each image the exclusion area.

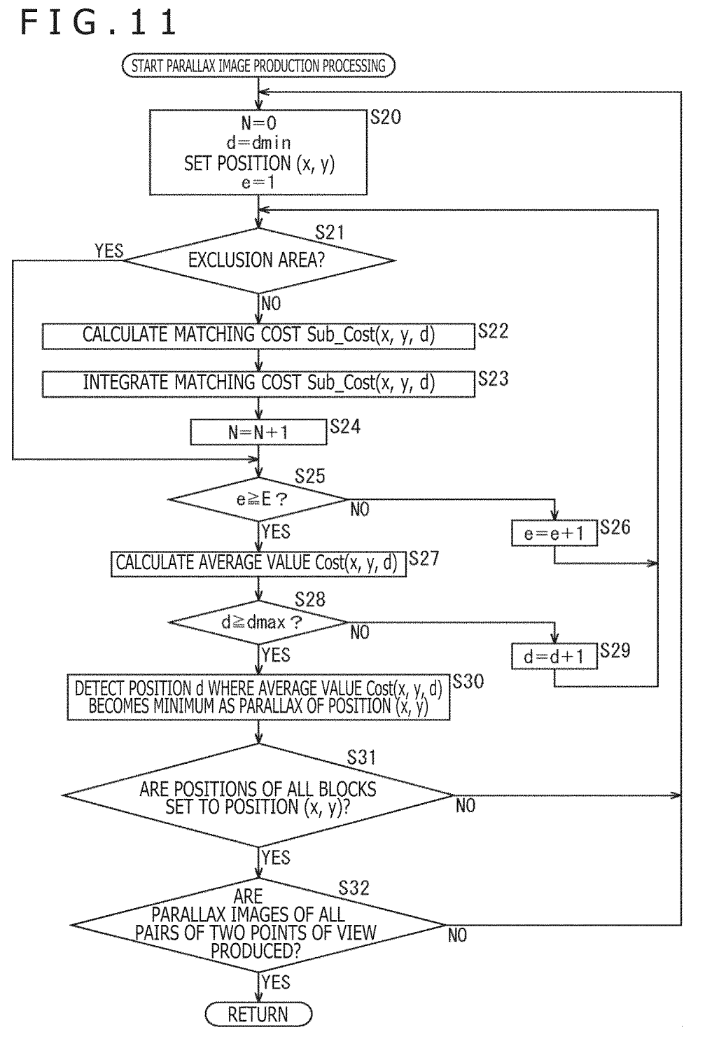

In Step S18, the parallax image producing portion 93 executes the parallax image production processing for producing the parallax image at the reference point of view of a pair of two points of view. The details of the parallax image production processing will be described with reference to FIG. 11 later.

In Step S19, the HDR image producing portion 74 carries out the three-dimensional re-configuration by using the parallax image of the reference point of view of each two points of view, and the same exposure pair images of the optimal exposure value of a plurality of exposure pair images, the pieces of data associated with which are supplied from the image processing portion 73, thereby producing the HDR omnidirectional image at each display point of view. The HDR image producing portion 74 supplies the data associated with the HDR omnidirectional image at each display point of view to the storage portion 75 and causes the storage portion 75 to store therein the data associated with the HDR omnidirectional image at each display point of view.

FIG. 11 is a flow chart explaining the parallax image production processing in Step S18 of FIG. 10.

In Step S20 of FIG. 11, the parallax image producing portion 93 sets a pair of two points of view which is not yet set as the processing target, and sets the number N of integration of the matching cost Sub_Cost(x, y, d) to 0. In addition, the parallax image producing portion 93 sets the position d in the depth direction to a minimum value dmin in the range of the position d corresponding to the range of the parallax set as the candidate, and sets the position (x, y) of the block on the image of the reference point of view to a position which is not yet set. Moreover, the parallax image producing portion 93 sets e indicating what number the kind of the exposure value is ranked of the kinds of exposure values of a plurality of exposure pair images at a pair of two points of view of the processing target to 1.

In Step S21, the parallax image producing portion 93 decides whether at least one of the blocks of the positions (x, y) of the image at the reference point of view obtained by projection-transforming the images of the same exposure pair images of the e-th exposure values at a pair of two points of view of the processing target with respect to a certain reference point of view into the position d in the depth direction is the exclusion area.

In Step S21, when it is decided that both the blocks of the positions (x, y) of the image at the reference point of view is not the exclusion area, the processing proceeds to Step S22. In Step S22, the parallax image producing portion 93 calculates the matching cost Sub_Cost(x, y, d) from the blocks of the positions (x, y) of the image at the reference point of view in accordance with Expression (1) described above.

In Step S23, the parallax image producing portion 93 integrates the matching costs Sub_Cost(x, y, d) calculated in Step S21 in the form of the integration value of the matching costs Sub_Cost(x, y, d) held therein, and holds therein the resulting integration value. It should be noted that in the case where the integration value of the matching costs Sub_Cost(x, y, d) is not yet held, the matching cost Sub_Cost(x, y, d) calculated in Step S21 is held as it is.

In Step S24, the parallax image producing portion 93 increments the integration value N by 1, and processing proceeds to Step S25.

On the other hand, in the case where it is decided in Step S21 that the block of the positions (x, y) of the image at at least one reference point of view is the exclusion area, the pieces of processing in Steps S22 to S24 are skipped, and the processing proceeds to Step S25. That is, in this case, any of the matching costs Sub_Cost(x, y, d) is not calculated, and thus the integration of the matching costs Sub_Cost(x, y, d) is not carried out.

In Step S25, it is decided whether e is equal to or larger than the number E of kinds of the exposure values of a plurality of exposed pair images at a pair of two points of view as the processing target. In the case where it is decided in Step S25 that e is not equal to or larger than the number N of kinds, in Step S26, the parallax image producing portion 93 increments e by 1. Then, the processing is returned back to Step S21, and the pieces of Steps S21 to S26 are repetitively executed until e becomes equal to or larger than the number E of kinds.

On the other hand, in the case where it is decided in Step S26 that e is equal to or larger than the number E of kinds, that is, in the case where the matching costs Sub_Cost(x, y, d) of all the exposure values in which the blocks of the position (x, y) of the images at both the reference points of view do not become the exclusion areas are integrated, the processing proceeds to Step S27.

In Step S27, the parallax image producing portion 93 divides the integration value of the matching costs Sub_Cost(x, y, d) by the number N of integration, thereby calculating the average value Cost(x, y, d) of the matching costs Sub_Cost(x, y, d).

In Step S28, the parallax image producing portion 93 decides whether the position d in the depth direction is equal to or larger than the maximum value dmax in the range of the position d corresponding to the range of the parallax set as the candidate. In the case where it is decided in Step S28 that the position d is not equal to or larger than the maximum value dmax, the processing proceeds to Step S29.

In Step S29, the parallax image producing portion 93 increments the position d in the depth direction by 1, and the processing is returned back to Step S21. Then, the pieces of processing Steps S21 to S29 are repetitively executed until the position d in the depth direction becomes the maximum value dmax.

On the other hand, in the case where it is decided in Step S28 that the position d is equal to or larger than the maximum value dmax, the processing proceeds to Step S30. In Step S30, the parallax image producing portion 93 detects the position d where the average value Cost(x, y, d) of the average values Cost(x, y, d) of the blocks of the positions (x, y) of the positions d becomes minimum as the parallax of the position (x, y).

In Step S31, the parallax image producing portion 93 decides whether the positions of all the blocks within the image at the reference point of view are each set to the position (x, y). In the case where it is decided in Step S31 that the positions of all the blocks within the image at the reference point of view are each not yet set to the position (x, y), the processing is returned back to Step S20. Then, the pieces of processing Steps S20 to S31 are repetitively executed until the positions at all the blocks within the image of the reference point of view are each set to the position (x, y).

In the case where it is decided in Step S31 that the positions of all the blocks within the image at the reference point of view are each set to the position (x, y), the processing proceeds to Step S32.

In Step S32, the parallax image producing portion 93 decides whether the parallax images at all pairs of two points of view are produced. In the case where it is decided in Step S32 that the parallax images at all pairs of two points of view are not produced, the processing is returned back to Step S20, and the pieces of processing Steps S20 to S32 are repetitively executed until the parallax images at all pairs of two points of view are produced.

On the other hand, in the case where it is decided in Step S32 that the parallax images of all pairs of two points of view are produced, the processing is returned back to Step S18 of FIG. 10, and proceeds to Step S19.

As described above, the image producing apparatus 12 produces the parallax image by using the area in which the exclusion areas of a plurality of exposure pair images are excluded. Therefore, the image producing apparatus 12 can produce the parallax image by using both the +EV pair images and the −EV pair images in the area other than the exclusion areas of the +EV pair images and the −EV pair images. Therefore, the accuracy of the parallax image can be enhanced as compared with the case where the parallax image is produced by using any one of the +EV pair images and the −EV pair images.

In addition, in the overexposure area of at least one of the +EV pair images, the image producing apparatus 12 can produce the highly accurate parallax image by using only the −EV pair images. Moreover, in the underexposure area of at least one of the −EV pair images, the image producing apparatus 12 can produce the highly accurate parallax image by using only the +EV pair images. Like the first embodiment, in the case where the photographing apparatus 11 photographs the image at points of view which spread by 360 degrees in the horizontal direction and by 180 degrees in the vertical direction, since the image at any of the points of view contains a light source, it is especially useful that even in the overexposure area or the like, the highly accurate parallax image can be produced.

Moreover, the image producing apparatus 12 can produce the highly accurate HDR omnidirectional image by using the highly accurate parallax image.

### (Example of Configuration of Display Apparatus)

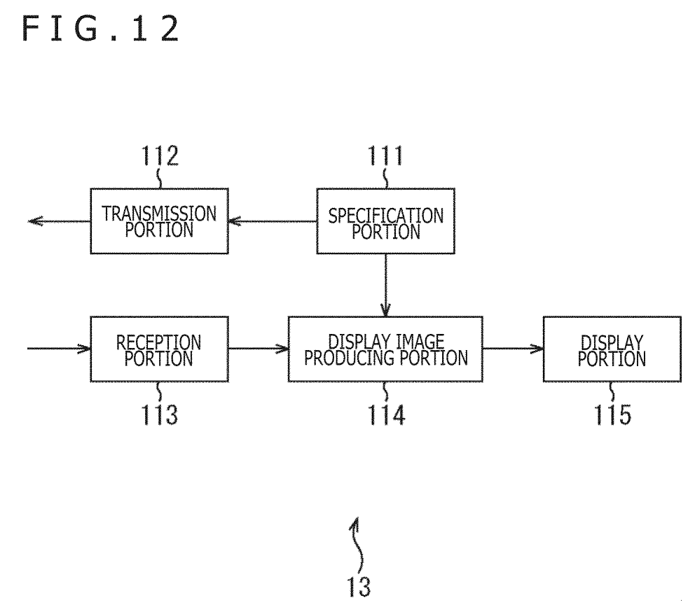

FIG. 12 is a block diagram depicting an example of a configuration of the display apparatus 13 of FIG. 1.

The display apparatus 13 of the photographing apparatus 11 includes a specification portion 111, a transmission portion 112, a reception portion 113, a display image producing portion 114, and a display portion 115.

The specification portion 111 of the display apparatus 13 receives an instruction to change the display point of view by the viewer (including specification of the first display point of view as well), and produces display point-of-view information associated with the display point of view. The specification portion 111 supplies the display point-of-view information to the transmission portion 112 and the display image producing portion 11. The transmission portion 112 transmits the display point-of-view information supplied thereto from the specification portion 111 to the image producing apparatus 12 of FIG. 1. The reception portion 113 receives the transmission data transmitted thereto from the image producing apparatus 12 of FIG. 1 and supplies the transmission data thus received to the display image producing portion 114.

The display image producing portion 114 transforms the number of bits for the transmission of the HDR omnidirectional image into the number of bits for the retention based on the restored data contained in the transmission data supplied thereto from the reception portion 113. The display image producing portion 114 changes the pixel values of the HDR omnidirectional image after change of the number of bits at the display point of view after change in such a way that the range of the pixel values of the HDR omnidirectional image after change of the number of bits at the display point of view after change indicated by the display point-of-view information supplied thereto from the specification portion 111 transfers in a step-by-step manner from the range of the pixel values of the HDR omnidirectional image after the change of the number of bits at the display point of view before the change. The display image producing portion 114 supplies the data associated with the HDR omnidirectional image in which the pixel values are changed as the display image to the display portion 115.

The display portion 115 displays thereon the display image the data associated with which is supplied thereto from the display image producing portion 114.

Incidentally, in the example of FIG. 12, since the number of bits of the image which can be displayed by the display portion 115 is the number of bits for the retention, the display image producing portion 114 transforms the number of bits for the transmission of the HDR omnidirectional image into the number of bits for the retention. However, in the case where the number of bits of the image which can be displayed by the display portion 115 is the number of bits for the transmission, the display image producing portion 114 does not carry out the change.

### (Description of Display Image)

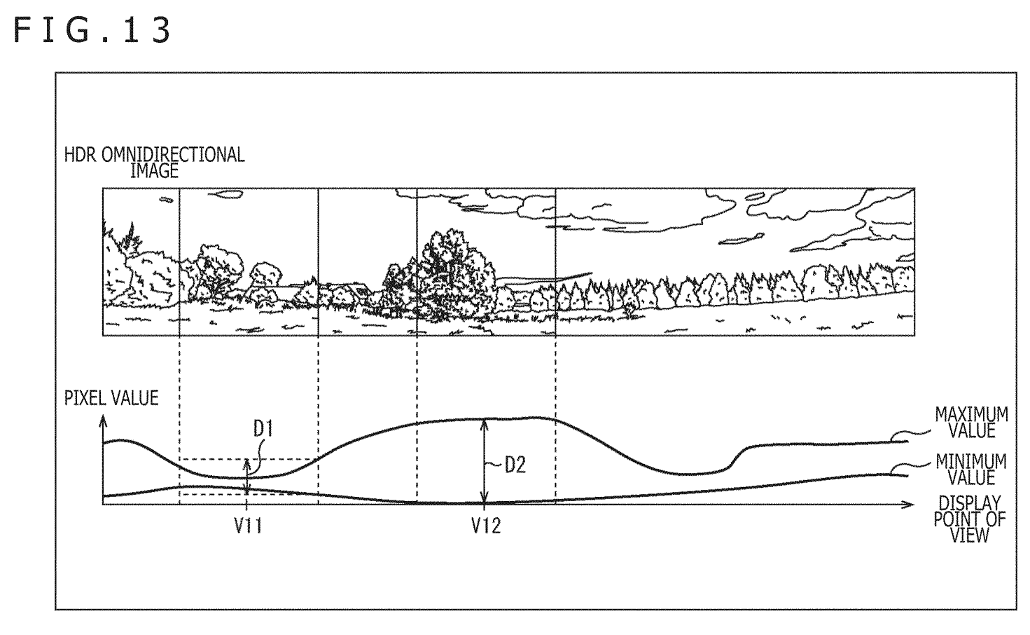

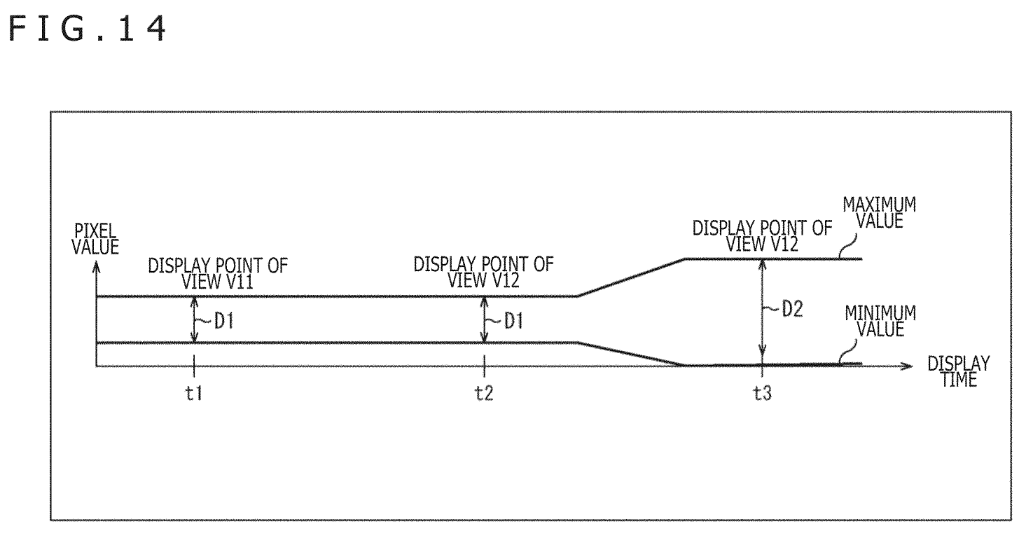

FIG. 13 is a view depicting the range of the pixel values of the HDR omnidirectional image at the display points of view after the number of bits by the display image producing portion 114. FIG. 14 is a view depicting the pixel value of the display image produced from the HDR omnidirectional image of the display points of view at which FIG. 13 indicates the range of the pixel values.

An upper stage of FIG. 13 depicts the HDR omnidirectional image after change of the number of bits at the display points of view represented by an axis of abscissa of a graph of a lower stage. The lower stage of FIG. 13 is a graph indicating the range of the pixel values of the HDR omnidirectional image at the display points of view after the transformation of the number of bits. In the graph of the lower stage of FIG. 13, the axis of abscissa represents the display point of view, and an axis of ordinate represents the pixel values of the HDR omnidirectional image at the display points of view. In addition, in the graph of FIG. 14, the axis of abscissa represents the display time, and the axis of ordinate represents the pixel values of the display image at each of the pieces of display time.

In the example of FIG. 13, the range of the minimum value and the maximum value of the pixel values of the HDR omnidirectional image at a display point V11 of view after the transformation of the number of bits is a range D1. In addition, the range of the minimum value and the maximum value of the pixel values of the HDR omnidirectional image at a display point V12 of view after the transformation of the number of bits is a range D2.

In this case, as depicted in FIG. 14, when at a display time t2, the display point of view indicated by the display point-of-view information is changed from the display point V11 of view to the display point V12 of view, the display image at the display time t2 is produced from the HDR omnidirectional image at the display point V12 of view after the transformation of the number of bits. However, the range of the minimum value and the maximum value of the pixel values is set to the range D1 of the HDR omnidirectional image at the display point V11 of view after the transformation of the number of bits. Then, for a period of time from the display time t2 to a display time t3, the range of the minimum value and the maximum value of the pixel values of the display image is transferred in a step-by-step manner from the range D1 of the HDR omnidirectional image at the display point V11 of view after the transformation of the number of bits to the range D2 of the HDR omnidirectional image at the display point V12 of view after the transformation of the number of bits.

Therefore, as compared with the case where at the display time t2, the range of the minimum value and the maximum value of the pixel values of the display image is abruptly changed from the range D1 to the range D2, the viewer can gradually acclimate his/her eyes to the range D2. In the case where the display image is the omnidirectional image, since the range of the minimum value and the maximum value of the pixel value largely differs depending on the display point of view in some cases, this is especially useful.

A period of time for the transition of the range of the minimum value and the maximum value of the pixel values of the display image may be set by a viewer, or may be previously set. In addition, only in the case where the change of the range of the pixel value between before the change of the display point of view and after the change of the display point of view is large, the range of the pixel values of the display image may be transferred in a step-by-step manner.

### (Description of Processing of Display Apparatus)

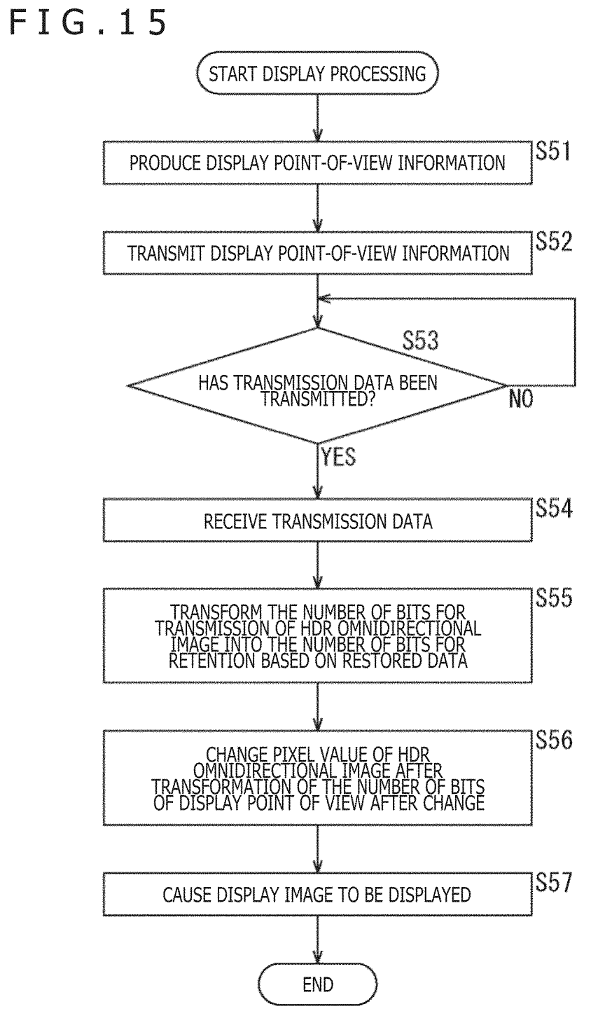

FIG. 15 is a flow chart explaining display processing of the display apparatus 13 of FIG. 12. This display processing is started when an instruction to change the display point of view is issued from the viewer.

In Step S51 of FIG. 15, the specification portion 111 of the display apparatus 13 receives the instruction to change the display point of view issued from the viewer, and produces the display point-of-view information of the display point of view concerned. The specification portion 111 supplies the display point-of-view information to each of the transmission portion 112 and the display image producing portion 114.

In Step S52, the transmission portion 112 transmits the display point-of-view information supplied thereto from the specification portion 111 to the image producing apparatus 12 of FIG. 1. In Step S53, the reception portion 113 decides whether the transmission data has been transmitted thereto from the image producing apparatus 12 in response to the display point-of-view information. In the case where it is decided in Step S53 that the transmission data is not yet transmitted, the reception portion 113 waits for until the transmission data has been transmitted.

On the other hand, in Step S53, in the case where the transmission data has been transmitted from the image producing apparatus 12, the reception portion 113 receives the transmission data transmitted thereto, and supplies the transmission data to the display image producing portion 114. In Step S55, the display image producing portion 114 transforms the number of bits for the transmission of the HDR omnidirectional image into the number of bits for the retention based on the restored data contained in the transmission data supplied thereto from the reception portion 113.

In Step S56, the display image producing portion 114 changes the pixel values of the HDR omnidirectional image after the transformation of the number of bits at the display point of view after the change in such a way that the range of the pixel values of the HDR omnidirectional image after the number of bits at the display point of view after the change indicated by the display point-of-view information supplied thereto from the specification portion 111 is transferred in a step-by-step manner from the range of the pixel values of the HDR omnidirectional image of the display point of view before the change.

In Step S57, the display image producing portion 114 supplies the data associated with the HDR omnidirectional image in which the pixel values are changed as the display image to the display portion 115, and causes the display portion 115 to display thereon the display image. Then, the processing is ended.

### Second Embodiment

### (Example of Configuration of Image Processing Portion in Second Example of Image Display System)

A configuration of a second embodiment of an image display system to which the present disclosure is applied is similarly to that of the image display system 10 of FIG. 1 except for the image processing portion. Therefore, hereinafter, a description will be given with respect to only the image processing portion.

FIG. 16 is a block diagram depicting an example of a configuration of the image processing portion in the second embodiment of the image display system to which the present disclosure is applied.

Of the constituent elements depicted in FIG. 16, the same constituent elements as those of FIG. 5 are individually assigned the same reference numerals, and a repeated description thereof will be suitably omitted here.

The configuration of the image processing portion 130 of FIG. 16 is different from that of the image processing portion 73 of FIG. 5 in that an area detecting portion 131 is provided instead of the overexposure area detecting portion 91 and the underexposure area detecting portion 93, and in that a parallax image producing portion 132 is provided instead of the parallax image producing portion 93. The image processing portion 130 produces a multi-level mask instead of the binary overexposure mask or underexposure mask.

Specifically, both the +EV pair images and the −EV pair images are supplied from the correction portion 90 to the area detecting portion 131 of the image processing portion 130. The area detecting portion 131 calculates values expressing the degrees of the exclusion areas of the blocks of the images of the +EV pair images and the −EV pair images.

More specifically, the area detecting portion 131 partitions the image into the blocks each having the predetermined size, and produces the histogram of the pixel values of the blocks. Then, the area detecting portion 131, for example, calculates the value representing the degree of the exclusion area which becomes larger as the number of pixel values each larger than the threshold value for the overexposure area decision becomes larger, or the number of pixel values each larger than the threshold value for the underexposure area decision becomes larger. The area detecting portion 131 produces the mask in which the value expressing the degree of the exclusion area of each of the blocks is set as the mask value. The mask value is the multi-level in the range of 0 to 1, and is large as the degree of the exclusion area is larger.

The parallax image producing portion 132 uses the mask of the image for each of the images of the +EV pair images and the −EV pair images the data associated with which is supplied from the area detecting portion 131, thereby setting weight to each of the blocks of each of the images in accordance with following Expression (3).

[Math. 3]

weight=(1.0+M(x,y)) (3)

M(x, y) is the mask value of the block in the position (x, y) within the image. According to Expression (3), the weight becomes necessarily a value larger than 1.

The parallax image producing portion 132, for example, detects the parallax of a pair of two points of view by using each of the blocks of a plurality of exposure pair images with the weight set for the block concerned every pair of two points of view in accordance with the plane sweeping method, thereby producing the parallax image.

Specifically, the parallax image producing portion 132 projection-transforms the same exposure pair images in which the weights are set to the blocks into the positions d in the depth direction corresponding to the parallaxes which become the candidates within the predetermined range with respect to the certain reference point of view, and produces the image at the reference point of view in the case where the subjects are present in the positions d. Then, the parallax image producing portion 132, similarly to the case of the parallax image producing portion 93 of FIG. 5, obtains the matching costs Sub_Cost(x, y, d) of the respective blocks in accordance with Expression (1) described above. It should be noted that the matching costs Sub_Cost(x, y, d) are calculated with respect to all the blocks.

The parallax image producing portion 132 carries out weighted addition for the matching costs Sub_Cost(x, y, d) of all the exposure values thus calculated in accordance with following Expression (3) every pair of two points of view, and obtains an average value Cost(x, y, d)′ of the weighted addition values.

$$\begin{matrix}[ Math . 4 ] & \\ Cost {( x , y , d )}^{′} = \frac{1}{L} {\sum }_{l = 0}^{L} {weight}^{′} ⋆ Sub\_Cost ( x , y , d ) & ( 4 )\end{matrix}$$

L is the number of kinds of the exposure values of a plurality of exposure pair images. In addition, weight′ is the weight which is determined based on the weights of the blocks before the projection transformation of the block I₀(x, y, d) and the block I₁(x, y, d) which are used in the calculation of the matching cost Sub_Cost(x, y, d).

The parallax image producing portion 132 detects the position d as the parallax in the case where the average value Cost(x, y, d)′ is smallest every block, and produces the parallax image at the reference point of view. The parallax image producing portion 132 supplies the data associated with the parallax image at the reference point of view of each of pairs of two points of view to the HDR image producing portion 74 of FIG. 4.

### (Example of Mask)

FIG. 17 is a view depicting an example of the mask produced by the area detecting portion 131 of FIG. 16.

In the example of FIG. 17, the subject is a person, a tree, and the sun, and the person is present on this side of the sun. Then, when the −EV pair images are photographed at the exposure value suitable for the sun, the person undergoes the underexposure. In this case, for example, the degrees of the exclusion area of an inner area of the person, an outer area of the person, an area of the tree, and other areas within one image of the −EV pair images are reduced in order. Therefore, the area detecting portion 131 produces a mask in which the mask values of the inner area of the person, the outer area of the person, the area of the tree, and other areas within one image of the −EV pair images are reduced in order. It should be noted that, in FIG. 17, the mask value is represented by light and shade of the colors, and thus as the color is deeper, the mask value is large.

The HDR omnidirectional image production processing of the image processing portion 130 of FIG. 16 is the same as the HDR omnidirectional image production processing of FIG. 10 except that the mask is substitute for the overexposure mask and the underexposure mask, and except for the parallax image production processing.

In addition, the parallax image production processing of the image processing portion 130 is the same as the parallax image production processing of FIG. 11 except that it is not decided whether the area concerned is the exclusion area, and except that the average value Cost(x, y, d)′ is calculated instead of the average value Cost(x, y, d).

As described above, the image processing portion 130 produces the multi-level mask based on the degrees of the exclusion areas of the images. Therefore, the degrees of the influence exerted on the parallax image of the image can be more finely set based on the degrees of the exclusion areas of the images. As a result, the highly accurate parallax image can be produced.

It should be noted that although in the first and second embodiments, both the overexposure area and the underexposure area are set as the exclusion areas, any one of them may be set as the exclusion area.

In addition, although in the first and second embodiments, the camera module is disposed so as to spread by 360 degrees in the horizontal direction, and by 180 degrees in the vertical direction, the camera module may be disposed so as to spread only by 360 degrees in the horizontal direction (circumferentially arranged side by side). In this case, by using the parallax image and a plurality of exposure pair images, the omnidirectional image which spreads by 360 degrees in the horizontal direction is produced.

Moreover, in the first and second embodiments, when the data associated with the HDR omnidirectional images at the display points of view are not previously stored, and only the display point-of-view information is received, only the HDR omnidirectional image at the display point of view indicated by the display point-of-view information may be produced.

In addition, a plurality of exposure pair images may be the moving image. The positions of a pair of two points of view corresponding to each of the same exposure pair images may be different from each other.

Moreover, although in the first and second embodiments, the display apparatus 13 produces the display image, alternatively, the image producing apparatus 12 may produce the display image, and may transmit the data associated on the display image to the display apparatus 13.

### Third Embodiment

(Description of Computer to which Present Disclosure is Applied)

The series of processing described above can be executed by hardware, or can be executed by software. In the case where the series of processing are executed by the software, a program composing the software is installed in a computer. Here, the computer includes a computer incorporated in a dedicated hardware, for example, a general-purpose personal computer which can carry out various kinds of functions by installing various kinds of parameters, and the like.

FIG. 18 is a block diagram depicting an example of a configuration of hardware of a computer which executes the series of processing described above in accordance with a program.

In a computer 200, a CPU (Central Processing Unit) 201, a ROM (Read Only Memory) 202, a RAM (Random Access Memory) 203 are connected to one another through a bus 204.

An I/O interface 205 is further connected to the bus 204. An input portion 206, an output portion 207, a storage portion 208, a communication portion 209, and a drive 210 are connected to the I/O interface 205.

The input portion 206 includes a keyboard, a mouse, a microphone or the like. The output portion 207 includes a display, a speaker or the like. The storage portion 208 includes a hard disc, a non-volatile memory or the like. The communication portion 209 includes a network interface or the like. The drive 210 drives a removable medium 211 such as a magnetic disc, an optical disc, a magneto-optical disc or a semiconductor memory.

In the computer 200 configured in the manner as described above, the CPU 201, for example, loads a program stored in the storage portion 208 into the RAM 203 through the I/O interface 205 and the bus 204, and executes the program, thereby executing the series of processing described above.

The program which is to be executed by the computer 200 (CPU 201), for example, can be recorded in the removable medium 211 as a package medium or the like to be provided. In addition, the program can be provided through a wired or wireless transmission medium such as a local area network, the Internet, or digital satellite broadcasting.

In the computer 200, the drive 210 is equipped with the removable medium 211, thereby enabling the program to be installed in the storage portion 208 through the I/O interface 205. In addition, the program can be received at the communication portion 209 and can be installed in the storage portion 208 through a wired or wireless transmission medium. Otherwise, the program can be previously installed in the ROM 202 or the storage portion 208.

It should be noted that the program which is to be executed by the computer 200 may be a program in accordance with which the pieces of processing are executed along the order described in the present description, or may be a program in accordance with which the pieces of processing are executed in parallel to one another or at a necessary timing when a call is made, or the like.

In addition, in the present description, the system means a set of a plurality of constituent elements (apparatus, module (components) or the like), and it does not matter whether or not all the constituent elements are present within the same chassis. Therefore, a plurality of apparatus which is accommodated in different chassis and is connected through a network, and one apparatus in which a plurality of modules is accommodated in one chassis are each the system.

It should be noted that the effects described in the present description are merely an exemplification, and are by no means limited, and thus other effects may be offered.

In addition, the embodiments of the present disclosure are by no means limited to the embodiments described above, and various changes can be made without departing from the subject matter of the present disclosure.

For example, the present disclosure can adopt a configuration of cloud computing in which a plurality of apparatuses shares one function to process the same in associated with one another through a network.

In addition, Steps described in the flow charts described above can be not only executed by one apparatus, but also executed so as to be shared among a plurality of apparatuses.

Moreover, in the case where a plurality of processing is included in one Step, the plurality of processing included in the one Step can be not only executed by one apparatus, but also executed so as to be shared among a plurality of apparatuses.

It should be noted that the present disclosure can also adopt the following constitutions.

(1)

An image producing apparatus, including:

a parallax image producing portion configured to, by using an area in which an exclusion area as at least one area of an overexposure area or an underexposure area within a plurality of exposure pair images photographed at a plurality of exposure values every pair of two points of view is excluded, produce a parallax image expressing parallax of the pair of two points of view.

(2)

The image producing apparatus according to (1) described above, further including:

a high dynamic range image producing portion configured to produce a high dynamic range image at a predetermined point of view by using the parallax image produced by the parallax image producing portion, and the plurality of exposure pair images; and

a transmission portion configured to transmit values, which is obtained by subtracting a minimum value of pixel values from the pixel values of the high dynamic range image produced by the high dynamic range image producing portion, and transforming the number of bits of a resulting difference into the number of predetermined bits, as the pixel values of the high dynamic range image.

(3)

The image producing apparatus according to (2) described above, in which the transmission portion is configured to transmit information indicating a range of pixel values of the high dynamic range image produced by the high dynamic range image producing portion.

(4)

The image producing apparatus according to (1) described above, further including:

a high dynamic range image producing portion configured to produce a high dynamic range image at a predetermined point of view by using the parallax image produced by the parallax image producing portion, and the plurality of exposure pair images,

in which a display apparatus displaying the high dynamic range image produced by the high dynamic range image producing portion, in a case where a point of view of the high dynamic range image to be displayed is changed, is configured to transfer in a step-by-step manner a range of pixel values of the high dynamic range image at a point of view after the change from the range of the pixel values of the high dynamic range image at a point of view before the change.

(5)

The image producing apparatus according to any one of (1) to (4) described above, in which the plurality of exposure pair images is configured to be photographed by a photographing apparatus which is provided every point of view and every exposure value.

(6)

The image producing apparatus according to any one of (1) to (4) described above,

in which the plurality of exposure pair images is configured to be photographed by a photographing apparatus provided every point of view, and

the photographing apparatus for each pair of two points of view is configured to photograph the plurality of exposure pair images by changing an exposure value in order.

(7)

The image producing apparatus according to any one of (1) to (6) described above, further including:

an area detecting portion configured to detect the exclusion area of the plurality of exposure pair images.

(8)

The image producing apparatus according to any one of (1) to (7) described above, in which the parallax image producing portion is configured to produce the parallax image by using weight corresponding to a degree at which an area is an exclusion area with respect to areas of the plurality of exposure images.

(9)

An image producing method, including:

a parallax image producing step of, by using an area in which an exclusion area as at least one area of an overexposure area or an underexposure area within a plurality of exposure pair images photographed at a plurality of exposure values every pair of two points of view is excluded, producing a parallax image expressing parallax of the pair of two points of view by an image producing apparatus.

### REFERENCE SIGNS LIST

12 Image producing apparatus, 13 Display apparatus, 31-1, 31-2, 32-1, 32-2, 51-1, 51-2 Camera, 74 HDR image producing portion, 77 Transmission portion, 91 Overexposure area detecting portion, 92 Underexposure area detecting portion, 93 Parallax image producing portion, 131 Area detecting portion, 132 Parallax image producing portion

1. An image producing apparatus, comprising:
a parallax image producing portion configured to, by using an area in which an exclusion area as at least one area of an overexposure area or an underexposure area within a plurality of exposure pair images photographed at a plurality of exposure values every pair of two points of view is excluded, produce a parallax image expressing parallax of the pair of two points of view.

2. The image producing apparatus according to claim 1, further comprising:
a high dynamic range image producing portion configured to produce a high dynamic range image at a predetermined point of view by using the parallax image produced by the parallax image producing portion, and the plurality of exposure pair images; and
a transmission portion configured to transmit values, which is obtained by subtracting a minimum value of pixel values from the pixel values of the high dynamic range image produced by the high dynamic range image producing portion, and transforming the number of bits of a resulting difference into the number of predetermined bits, as the pixel values of the high dynamic range image.

3. The image producing apparatus according to claim 2, wherein the transmission portion is configured to transmit information indicating a range of pixel values of the high dynamic range image produced by the high dynamic range image producing portion.

4. The image producing apparatus according to claim 1, further comprising:
a high dynamic range image producing portion configured to produce a high dynamic range image at a predetermined point of view by using the parallax image produced by the parallax image producing portion, and the plurality of exposure pair images,
wherein a display apparatus displaying the high dynamic range image produced by the high dynamic range image producing portion, in a case where a point of view of the high dynamic range image to be displayed is changed, is configured to transfer in a step-by-step manner a range of pixel values of the high dynamic range image at a point of view after the change from the range of the pixel values of the high dynamic range image at a point of view before the change.

5. The image producing apparatus according to claim 1, wherein the plurality of exposure pair images is configured to be photographed by a photographing apparatus which is provided every point of view and every exposure value.

6. The image producing apparatus according to claim 1,
wherein the plurality of exposure pair images is configured to be photographed by a photographing apparatus provided every point of view, and
the photographing apparatus for each pair of two points of view is configured to photograph the plurality of exposure pair images by changing an exposure value in order.

7. The image producing apparatus according to claim 1, further comprising:
an area detecting portion configured to detect the exclusion area of the plurality of exposure pair images.

8. The image producing apparatus according to claim 1, wherein the parallax image producing portion is configured to produce the parallax image by using weight corresponding to a degree at which an area is an exclusion area with respect to areas of the plurality of exposure images.

9. An image producing method, comprising:
a parallax image producing step of, by using an area in which an exclusion area as at least one area of an overexposure area or an underexposure area within a plurality of exposure pair images photographed at a plurality of exposure values every pair of two points of view is excluded, producing a parallax image expressing parallax of the pair of two points of view by an image producing apparatus.
